(19) United States
(12) Patent Application Publication
(10) Pub. No.: US 2022/0202641 A1
(43) Pub. Date: Jun. 30, 2022

(54) PHYSICAL CONDITIONING AND THERAPEUTIC CONDITIONING PIVOTING SYSTEM

(71) Applicants: Steven Reisman, Los Angeles, CA (US); Glenn Gorden, Malibu, CA (US)

(72) Inventors: Steven Reisman, Los Angeles, CA (US); Glenn Gorden, Malibu, CA (US)

(21) Appl. No.: 17/561,908

(22) Filed: Dec. 24, 2021

Related U.S. Application Data
(60) Provisional application No. 63/130,587, filed on Dec. 24, 2020.

(51) Int. Cl. A61H 1/00

(52) U.S. Cl. CPC A61H 1/005; A61H 2201/1626; A61H 2201/0149

(57) ABSTRACT

A physical conditioning and therapeutic conditioning system that, when configured and incorporated into the construction of a chair, has a seat, a base configured to rest on a surface, and a seat-support mechanism which is configured to couple the seat to the base and enables the seat, when unlocked in one embodiment, to be pivoted in any direction while rocking in the seat and using one's own body weight for resistance. Ideally the seat-support mechanism permits universal motion in all directions above a vertical axis, including front to back inflection and side-to-side inflection of at least 40° , including 360° of rotation on a universal type joint. The universal type joint is a ball joint consisting of a bearing stud and socket enclosed in a case, with all parts made of steel. In one embodiment, the bearing stud is tapered and fits into a hydraulic post. A ball joint is used to allow free rotation in two planes at the same time.

The universal ball joint when attached to the underside of a seat is surrounded by a metal caste collar, also attached to the underside of the seat, and with a locking system attached to the upper collar. Inserted into the upper collar, along with a lower collar attached to the arm support structure, surrounding the ball joint assembly is a hardened metal coiled spring, used ideally to stabilize, through compression, the seat in a horizontal position and allow for locking the seat in a horizontal position, when no force is applied or when not in use.

### CROSS-REFERENCE TO RELATED APPLICATION

This application claims the benefit of U.S. Provisional Application No. 63/130,587, filed 24 Dec. 2020, entitled Flexor Pivoting System.

### REFERENCE REGARDING FEDERAL SPONSORSHIP

Not Applicable

### REFERENCE TO MICROFICHE APPENDIX

Not Applicable

1. Field of the Invention

The present invention relates to a therapeutic and physical conditioning pivoting system, in particular, to improved mobility and flexure imparted thereby to industrial, commercial, office and home equipment and furniture and, in particular, to enabling a movable member, such as a chair seat, to provide it with a 360 degree motion.

2. Description of Related Art and Other Considerations

Back pain and related symptoms rank among the second most frequent medical complaints. Disability from low back pain (spine related disorders) is second only to the common cold as a cause of lost work time and is the most common cause of disability in people under 45 years of age. In the United States, the prevalence of back pain will affect an estimate almost 80% of individuals at some time in their life.

Lifting and bending accidents have been assumed to be the common cause of back injuries. Notwithstanding this assumption, approximately 80% of the US population now have sedentary jobs requiring them to sit for up to eight hours a day. Add to this the time required sitting for travel to and from work, and watching television or resting, an individual may be sitting up to 15 hours per day.

The onset of acute low back pain most often is the result of mechanical damage due to excessive and prolonged poor posture and mechanics, a sedentary lifestyle and inadequate conditioning. Seemingly trivial stress such as bending over, sneezing or coughing can produce a herniated disk when superimposed on chronic wear and tear. People in a sedentary occupation have a high risk of herniating a disk.

Mobile tissue, in particular the spine, is susceptible to a variety of disorders resulting from active misuse and sedentary neglect. Up to 90% of chronic pain is located in the musculoskeletal system. The prevalence of pain commonly occurs in the head, neck, shoulders, low back, legs, and pelvis.

The best treatment and maintenance of healthy mobile tissue, such as the spine, is motion. The biomechanics of the spine involve any number of degrees of motion (e.g., flexion extension, rotation, lateral bending and long-axis distraction and compression-load/unload cycling). Daily full range of motion exercises, identified as “osmosis and imbibition” is essential for daily metabolic interchange in adults. Nutrition intake and elimination of waste products, through such actions, must occur in order to maintain healthy, well hydrated spinal disks, ligaments and tendons.

Core muscles are the sturdy link in a chain connecting the upper and lower body. A strong, flexible core underpins almost everything one does. No matter where motion starts, it goes upward and downward to adjoining links of the chain, with the necessary motions either originating in the core or moving through it. Weak or inflexible core muscles can impair how well one's arms or legs function. A strong core enhances balance and stability. A strong flexible core underpins almost everything one does from everyday acts (bending, turning, sitting, bathing, dressing), to on the job tasks (lifting and standing), a healthy back, sports and other pleasure activities, housework and gardening. Balance and stability as well as good posture, are the result of strong core muscles.

When core muscles contract, they stabilize the spine, pelvis, and shoulder girdle and create a solid base of support for powerful movements of ones' extremities. Core conditioning exercises need to target all muscle groups to be effective.

Weak core muscles result in a loss of the lumbar curve and a swayback posture. Stronger, balanced core muscles help maintain appropriate posture and reduce strain on the spine.

Because the muscles of the trunk and torso stabilize the spine from the pelvis to the neck and shoulder, they allow the transfer of power to the arms and legs. Core strengthening exercises are most effective when the torso works as a solid unit with both front and back muscles contracting at the same time.

### SUMMARY OF THE INVENTION

These and other problems are successfully addressed and overcome by the present invention by the utilization of a positioning device such as effected by a moveable member as embodied as a seat, a seat-supporting structure, and a three-dimensional springy mechanism existing between the seat and the seat-supporting structure for enabling a user of the seat or other such positioning device to provide a three-dimensional (360 degree) pivoting for effecting the therapeutic and physical conditioning. Such a three-dimensional springy mechanism contemplated herein includes spring surrounding a ball and socket and a pressure plate secured to the socket that enables the 360 degree motion.

### BRIEF DESCRIPTION OF THE DRAWINGS

FIG. 1 depicts a first embodiment of the present inventive device in perspective embodying a three-dimensional springy mechanism that enables a chair which can be pivoted about 360° and which has a back support, in which the first embodiment is numbered in the 100 series;

FIG. 2 is an exploded view of the embodiment shown in FIG. 1;

FIG. 3 is a view similar to that illustrated in FIG. 2 but turned 90° therefrom;

FIG. 4 is an exploded perspective view of the three-dimensional springy mechanism depicted in FIGS. 1-3;

FIG. 5 is a perspective cross-sectional view of the assembled three-dimensional springy mechanism shown in FIG. 4;

FIG. 6 is plan view in partial cross-section of the present invention shown in FIGS. 1-3;

FIG. 7 is an exploded perspective view of a portion illustrated in FIGS. 1-6 showing the seat and the three-dimensional springy mechanism;

FIG. 8 is a larger view of that which is shown in FIG. 7;

FIG. 9 is side view of the complete device in partial cross-section as illustrated in FIGS. 1-3 and 6;

FIG. 10 is a perspective view of the three-dimensional springy mechanism;

FIG. 11 is a perspective rear view of the previously shown device;

FIG. 12 is another perspective rear view of the previously shown device, taken higher than that as illustrated in FIG. 11;

FIG. 13 is an exploded three-dimensional view of another representation of the present inventive device embodied also as a flexor system exemplified as a flexor chair, which figure and subsequent figures are numbered in the 200 series which correspond to the prior figures numbered in the 100 series;

FIG. 14 is a one-hundred eighty degrees turned exploded three-dimensional view of the present invention as shown in FIG. 13;

FIG. 15 is an exploded three-dimensional view of the flexor chair depicted in FIGS. 13 and 14 showing its integral parts;

FIG. 16 is is a plan view of the flexor chair interior parts illustrated in FIGS. 13-15 showing the parts assembled together;

FIG. 17 is a three-dimensional view of the assembled flexor chair interior parts depicted in FIG. 16;

FIG. 18 illustrates an assembled further three-dimensional view of the interior flexor chair parts;

FIG. 19 depicts a assembled still further three-dimensional view of the interior flexor chair parts similar to that illustrated in FIG. 18 but without the main spring to show a spring-loaded locking feature in which a lever is normally torqued into its locking position; and

FIG. 20 shows a modification of the flexor chair illustrated in FIGS. 13-19 including two more rods added to the chair's pressure plate, increasing their number to four stabilizing rods.

### DETAILED DESCRIPTION

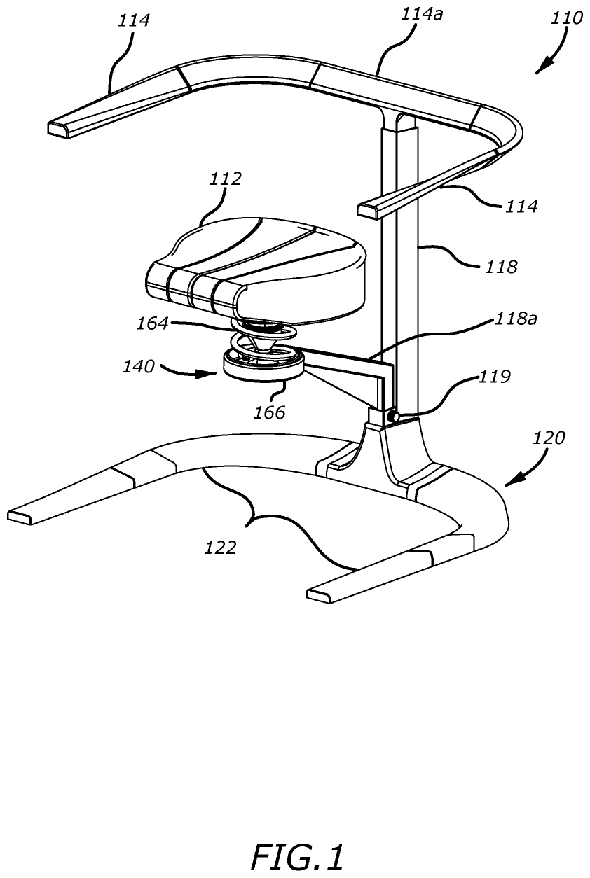

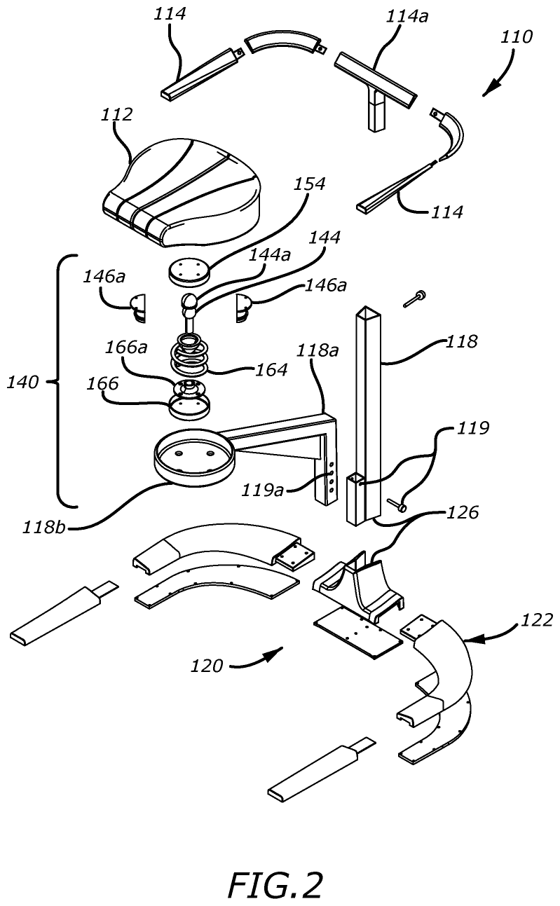

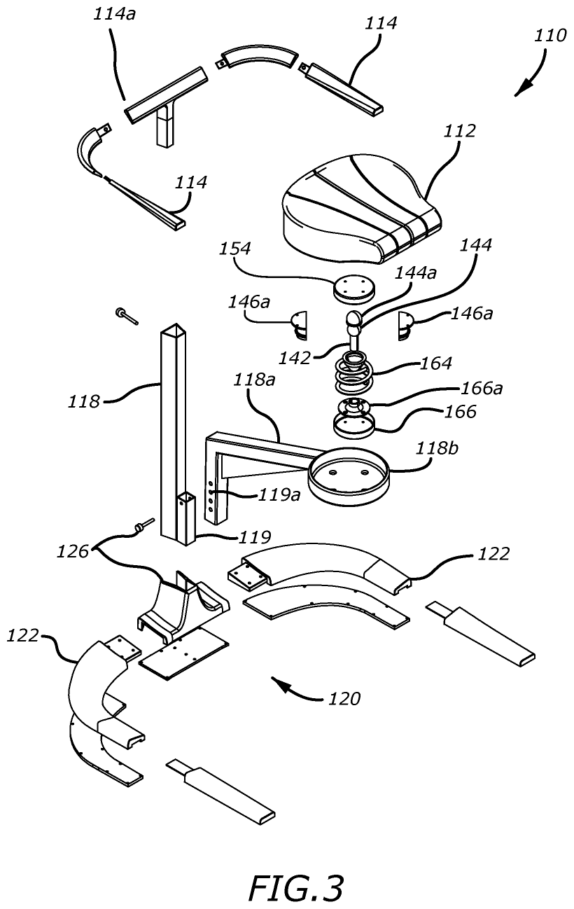

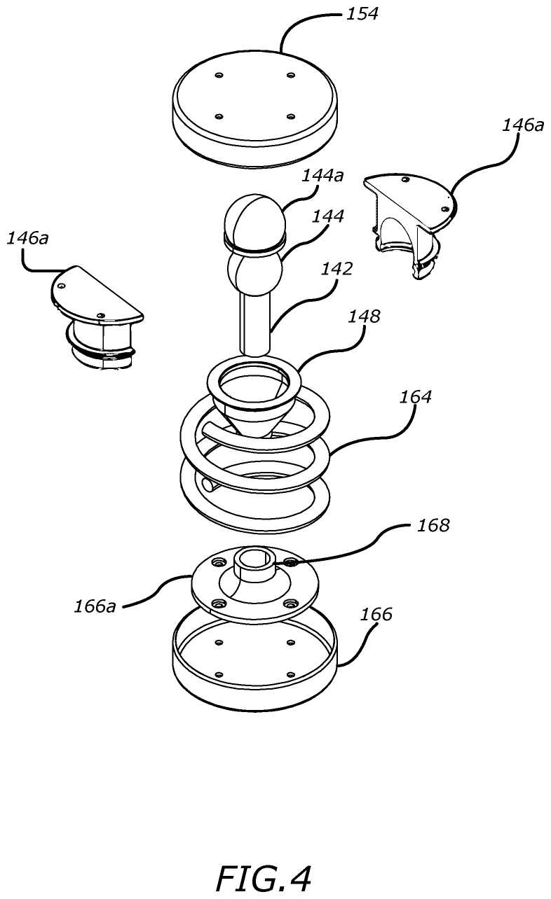

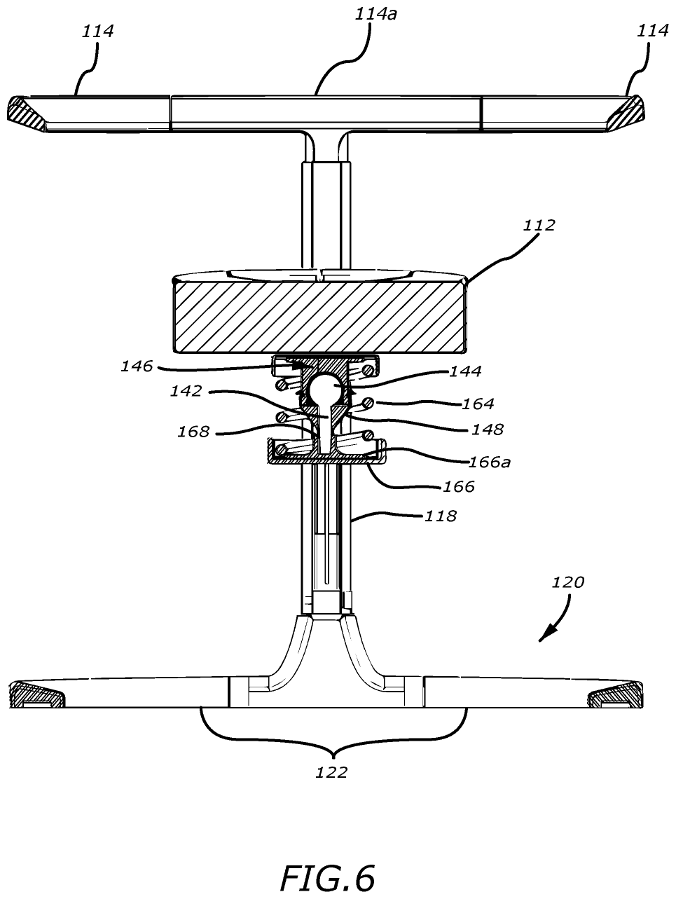

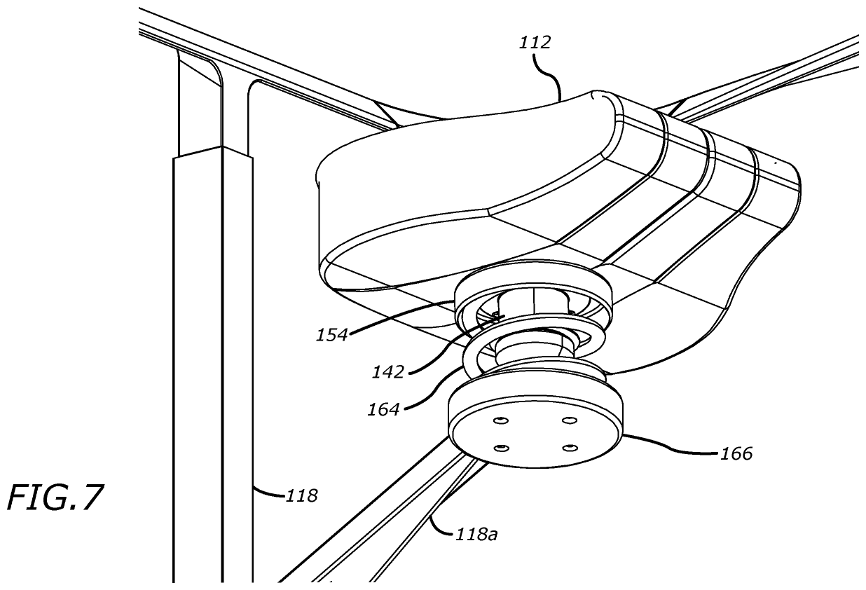

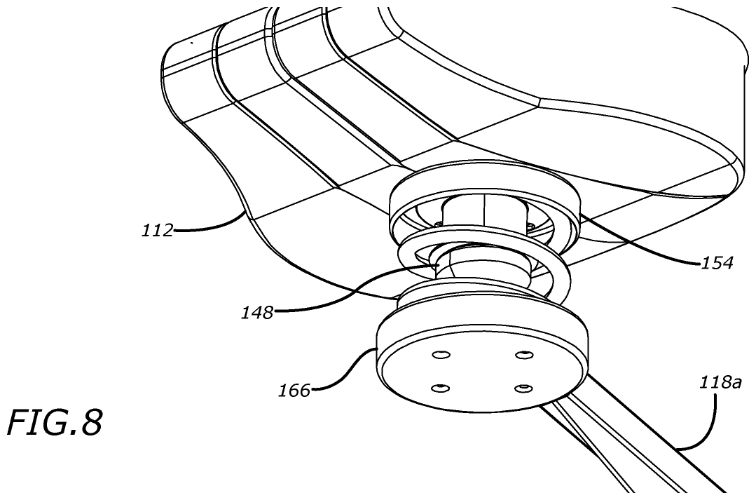

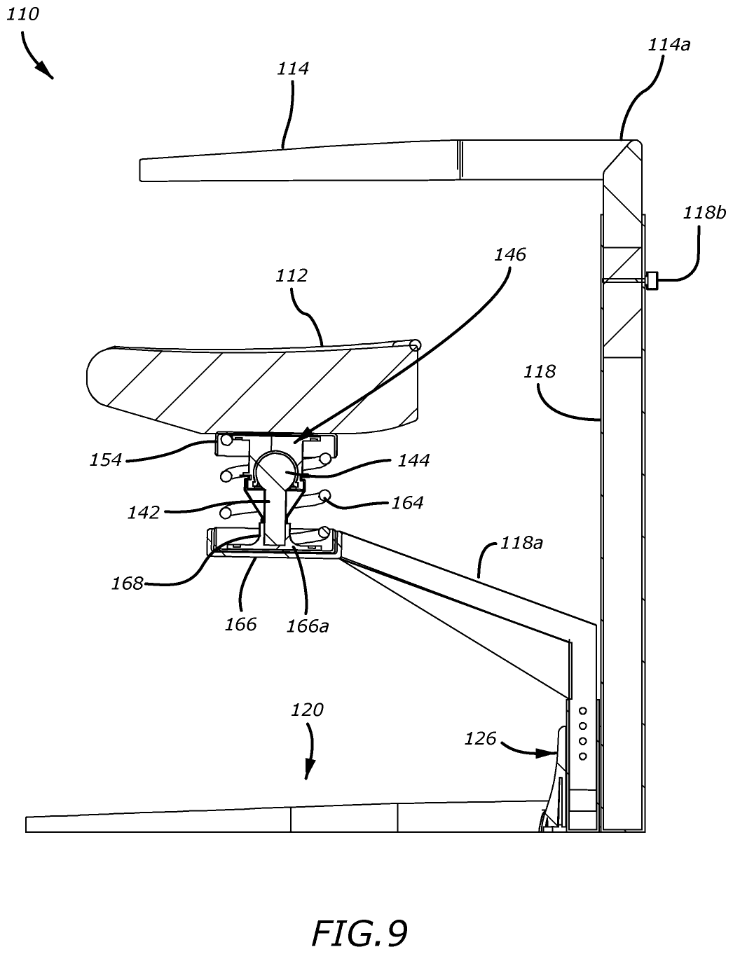

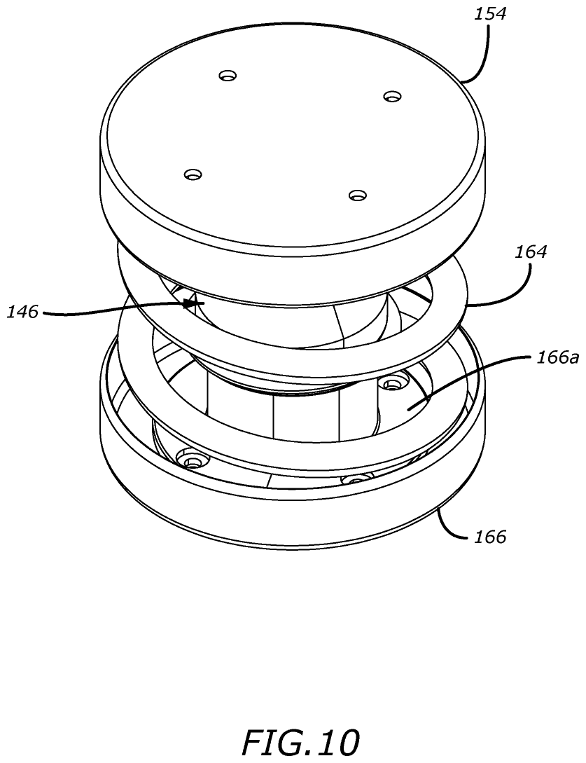

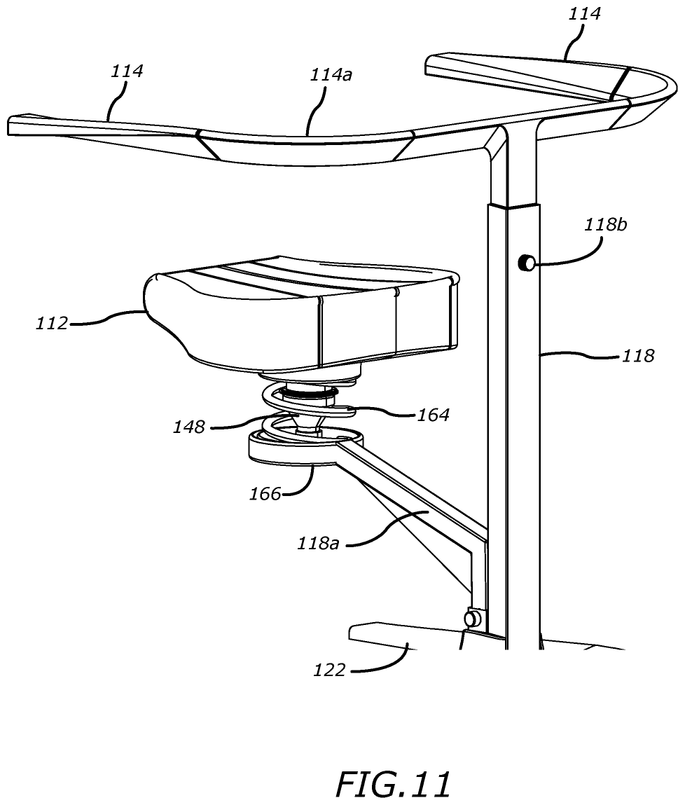

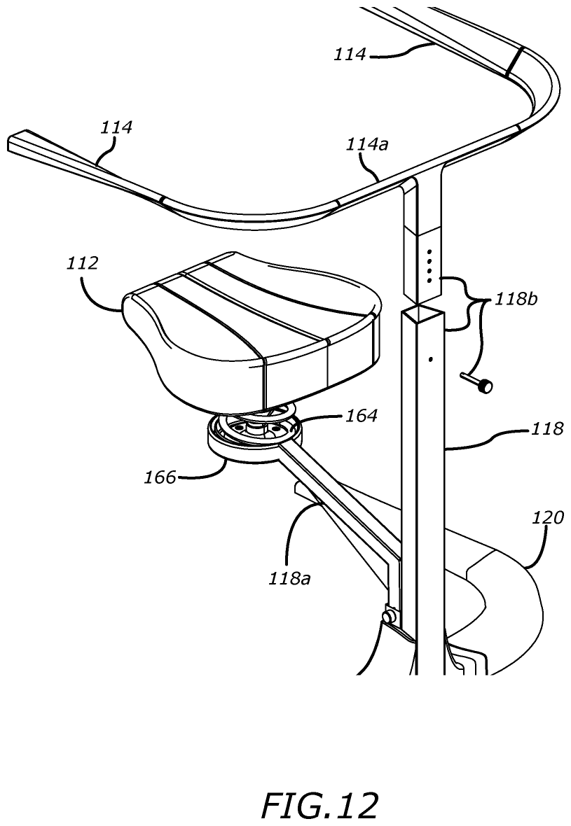

Accordingly, as shown in FIGS. 1-12, the present invention, as embodied and illustrated as a flexor chair 110, includes a seat 112 and accompanying handles 114 and backrest 114a from which a chair post 118 extends. As illustrated in FIG. 11 (see also FIGS. 2 and 3), handle 114 and backrest 114a are jointly engaged by a downwardly extending extension within post 118; while not shown, the downwardly extending extension is provided with spaced openings, to be engaged by a pin 118b, to enable the raising and lowering of handles 114 and backrest 114a to accommodate different users of flexor chair 110. Post 118 is secured to a base 120 which includes a pair of legs 122 of conventional construction. Extending from post 118 is an angled arm 118a to which a 360 degree seat support flexor mechanism (or alternately described three-dimensional springy mechanism) 140 is attached. Seat 112 is secured atop mechanism140.

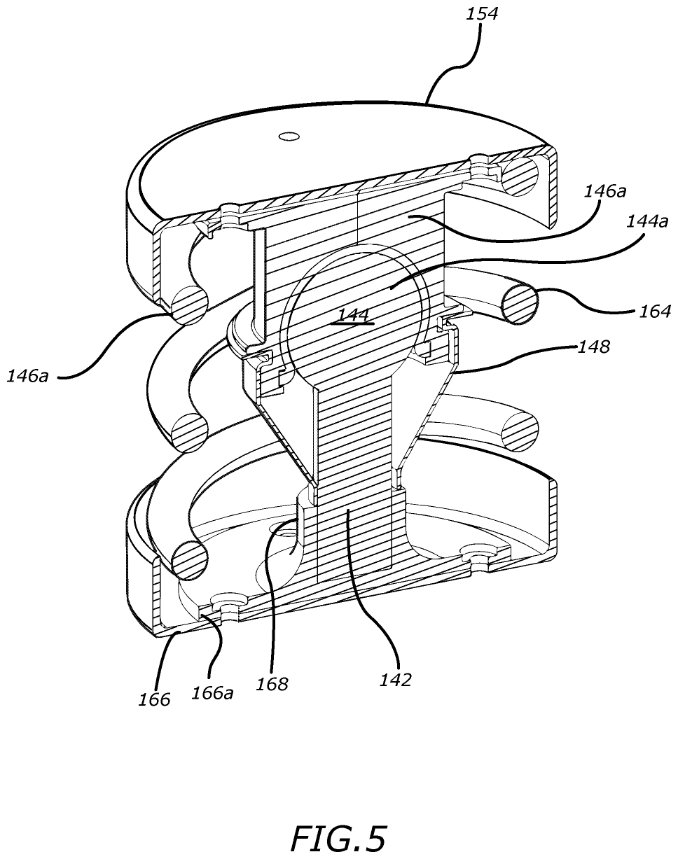

Mechanism 140, as shown in FIGS. 1-12, includes a center spring 164 which is bounded by a pressure plate 154 at the upper end of mechanism 140. Pressure plate 154 is secured to seat 112 by any appropriate means. The lower end of mechanism 140 is supported by a cup supporting spring 164 which is secured to an end of angled arm 118a. Spring 164 is therefore held and contained between pressure plate 154 and cup 166 and provides a biasing force therebetween. Cup 166 supports a ring-shaped element 166a (see FIG. 2) which, as also illustrated in FIG. 5, is provided with a center receptacle 168. A post 142 is disposed at its lower end to reside within and be supported by receptacle 168 and cup 166.

A ball 144 is formed at the upper end of interior post 142 and provides the 360° movement which is afforded by seat-support mechanical flexor mechanism 140 and which is directed to seat 112. Handles 114 and backrest 114a provides stability for a user sitting on seat 112 during its 360° movement. The coupling between ball 144 and seat 112 includes a ball retainer socket146 formed from ball retainer socket halves 146a. A slip-cover 144a (see also FIGS. 2 and 3) encloses ball 144 to aid movement and slippage between the ball and socket 14. The bias afforded by spring 164 assures retention of the ball within its socket.

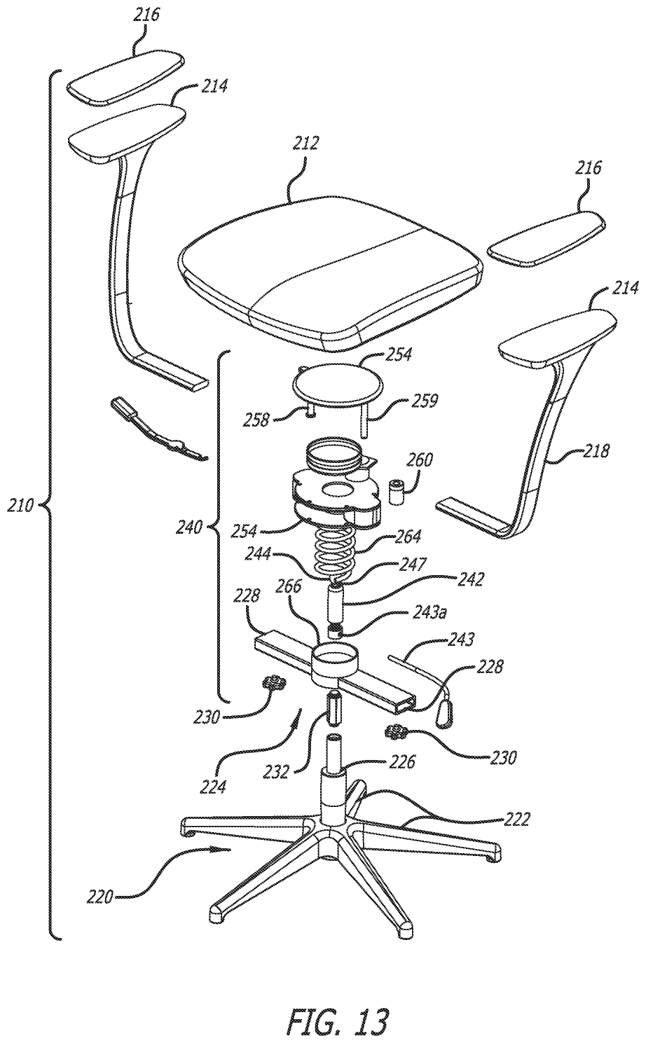

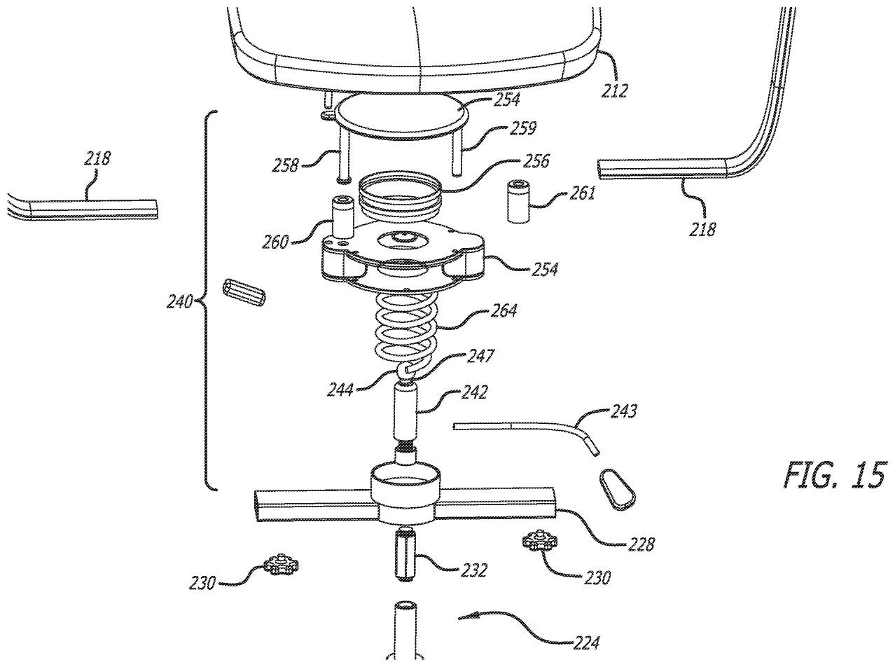

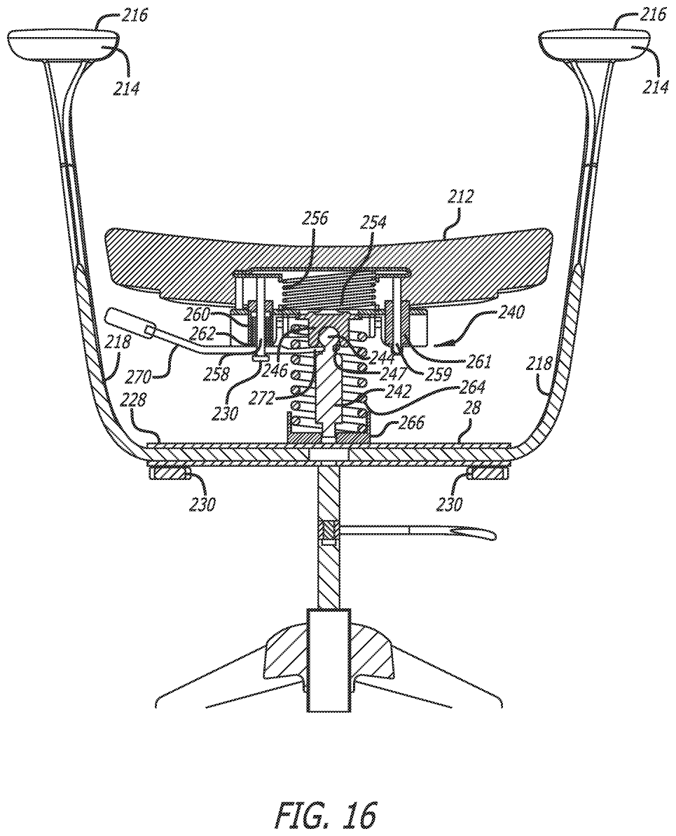

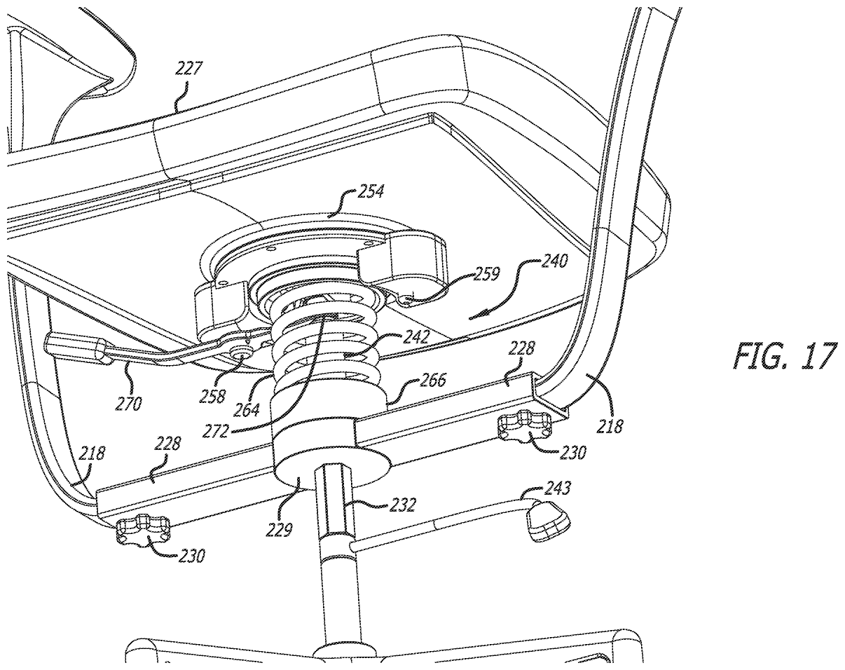

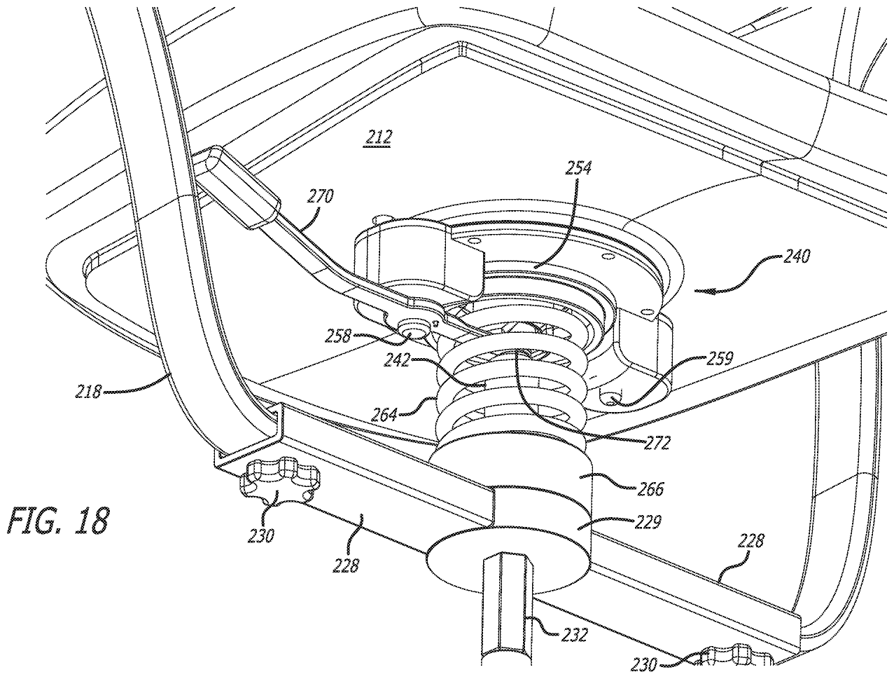

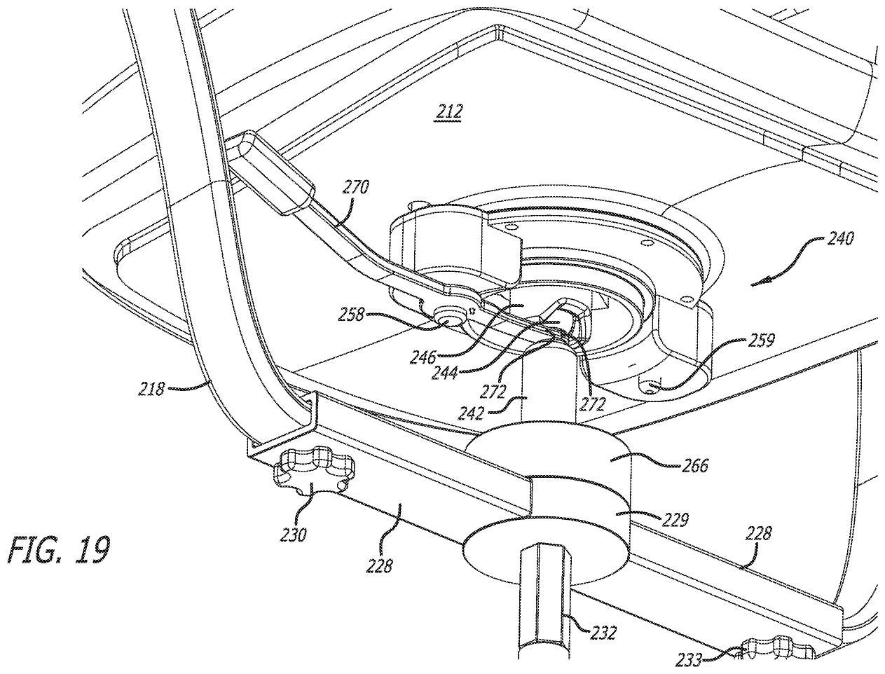

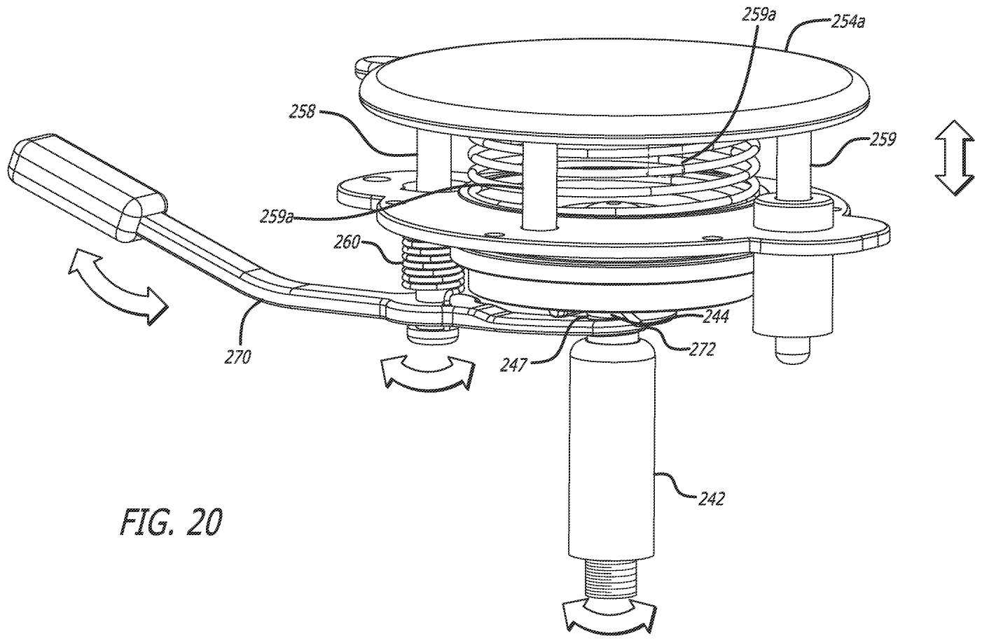

As additionally shown in FIGS. 13-20, the present invention, as embodied and illustrated as a flexor chair 210, includes a seat 212 and accompanying handles 214 and arm and hand pads 216, from which the chair attachments 218 extend. The seat is secured to a base 220 which includes five legs 222 of conventional construction. Extending from legs 222 of base 220 is a support 224 including a coupling 226. Secured atop support 224 are a pair of oppositely extending sleeves 228 which extend from a central hub 229. As shown in FIGS. 16-17, the ends of attachments 218 attach handles 214 within sleeves 228. Hand nuts 230 screw into the sleeves to securely affix the attachments therein. A hexagonal piece 232 couples hub 229 and upper parts to coupling 226.

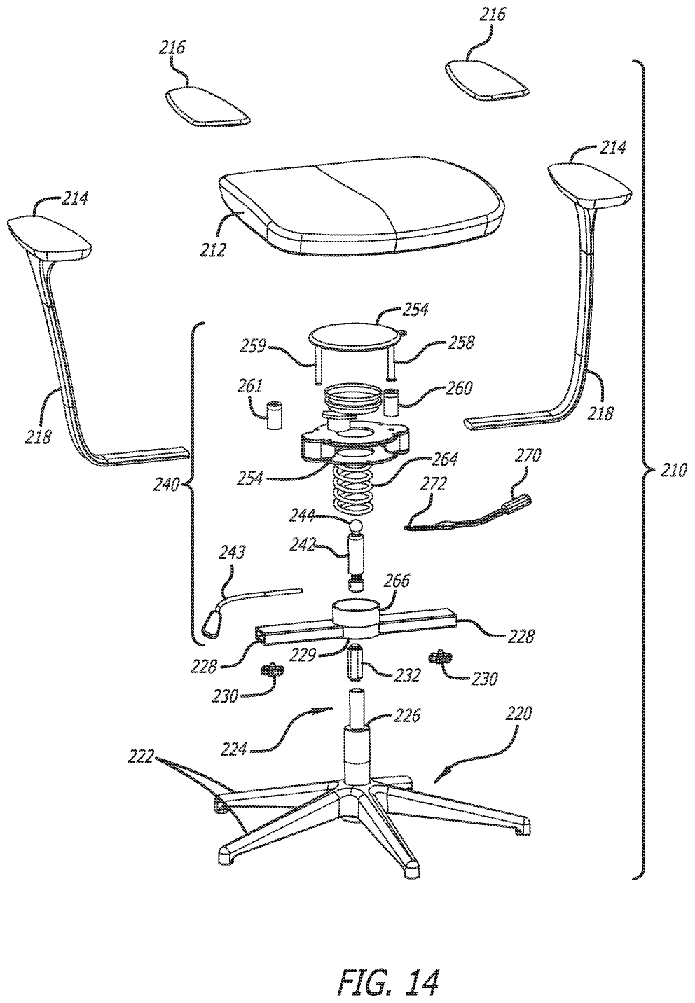

A shown in FIGS. 13-16, a 360° seat-support mechanical flexor mechanism 40 couples seat 212 to the lower structure including base 220 to provide a full side-to-side and a full front-to-back flexion on a 360° universal-type joint for the seat. Mechanism 240 includes an interior post 242 having a longitudinal axis extending from the seat to the base. The lower end of post 242 is secured to central hub 229 by a tightening tool 243 engaging a tightening screw 243a (shown in FIG. 13) engaging the post lower end of post 242. Interior post 242 is topped with a ball 244 which is disposed to engage a socket 246 (underlying pressure plate 254) to form a 360° ball joint for according such actuation of the chair. Socket 246 is remotely secured to seat 212. A lever engaging space 247 is formed between the upper portion of post 242 and ball 244 for purposes that will be discussed below. The structure coupling socket 46 to seat 212 includes a pressure plate254, a spring 256, and rods 258 and 259 extending respectively through cylinders 260 and 261 and an interior spring 262 for cylinder 260 through which rod 258 passes, such as shown in FIGS. 13-14 and best in FIG. 17. A larger spring 264, which surrounds post 242, is fitted within its lower end within a cup 266 which is formed as part attached to sleeves 228 and central hub 229. Spring 264 at its upper end abuts against part 254 and, when 360° seat-support mechanical flexor mechanism 240 is assembled, spring 264 is compressed.

As shown in FIGS. 14-17, mechanism 240 is normally locked to prevent movement of seat 212 by use of a lever 270 which is hinged to bolt 258. As best seen in FIGS. 16 and 17, one end 272 of the lever has a notched U-shaped end which is adapted to fit within lever engaging space 247 and, when so fitted in, the 360° seat support mechanical mechanism 240 is held in place to prevent any full side-to-side and full front-to-back flexion for seat 212. Torque spring 260 normally biases notched U-shaped end 272 of lever 270 within space 247 which, as described above, is positioned between ball 244 and its securement to post 242.

FIG. 11 illustrates a flexor chair modification comprising a modified pressure plate 254a which includes two more rods 259a that provide additional stability to existing rods 258 and 259.

In use, when full side-to-side and full front-to-back flexion of seat 212 on the 360° universal-type joint is desired, lever 270 is pivoted away from lever-engaging space 247 so that ball 244 is permitted to move freely within socket 246. Such use involves the following considerations and thoughts.

Hip flexors are a group of muscles near the top of your thighs that are key players in moving your lower body. They let you to walk, kick, bend, and swivel your hips. But if your muscles are too tight or if you make a sudden movement, your hip flexors can stretch or tear, which can significantly limit one's activity and mobility.

A hip flexor strain can be mildly uncomfortable or so serious that you have trouble walking and have muscle spasms and lot of pain.

Regular stretches can help keep your hip flexors loose and prevent injuries.

Pain in the side of your hip most often results from one of the following conditions:

Tendinitis. This is an inflammation of the tendons (fibrous bands of tissue) that connect the gluteal muscles in your buttocks to the hip bone. “Tendinitis develops because of muscle imbalance. It could be from a lack of activity, crossing your legs, or even sitting on a wallet.

Overuse injury. When you walk or run, weak hip and buttock muscles can tighten and irritate the iliotibial (IT) band—a long band of connective tissue that runs from the knee to the hip. It merges with the gluteal muscles to stabilize the leg.

Tight muscles in the buttocks and hip. If the gluteal muscles and IT band are too tight, they pull at the thighbone where they attach, and that causes pain on the side.

A hip flexor strain can be mildly uncomfortable or so serious that one may have trouble walking along with muscle spasms and lot of pain.

Regular stretches can help keep your hip flexors loose and prevent injuries. Use of the device allows various forms of stretching from beginner to advanced.

Although the invention has been described with respect to particular embodiments thereof as exemplified with respect to a chair, it should be realized that various changes and modifications may be made therein without departing from the spirit and scope of the invention, in particular for gym, home exercising, office ergonomic task chair and health and well-being benefit for three hundred-sixty pivoting system, in general therefore, for medical and well-fulness benefit including industrial and tech industry, such as 3D printing machines.

What is claimed is:

1. A therapeutic and physical conditioning pivoting system comprising a movable member, a supporting structure therefor, and a three-dimensional springy mechanism existing between said movable member and said movable member-supporting structure for enabling a user of said movable member to provide a three-dimensional pivoting for the therapeutic and physical conditioning.

2. The system according to claim 1 in which said three-dimensional springy mechanism includes a stationary ball and a movable ball retainer coupled to said movable member for providing a 360° universal-type joint.

3. The system according to claim 1 in which said three-dimensional springy mechanism includes a stationary ball and a movable ball retainer coupled to said movable member for permitting universal motion of said movable member in all directions above a vertical axis, including front to back inflection and side-to-side inflection of at least 40° , including 360° of rotation.

4. The system according to claim 2 further including elements disposed above said ball retainer and below said ball, and a bias-providing device interposed between said elements for ensuring the establishment of said 360° universal-type joint.

5. The system according to claim 3 further including a post which is secured to said ball and which extends downwardly to and into contact with one of said elements disposed below said ball, and further in which said bias-providing device comprises a spring surrounding said post.

6. The system according to claim 3 further including apparatus coupled to said three-dimensional springy mechanism for alternately stopping and enabling operation of said three-dimensional springy mechanism.

7. The system according to claim 5 in which said apparatus composes a lever having an end engageable and disengageable with said ball and a spring biasing said lever end into engagement with said ball.

8. The system according to claim 1 wherein said movable member comprises a seat.

9. The system according to claim 8 further including a stationary post and legs, a backrest and handles extending from said backrest movably secured to said stationary post in a vertical direction for adapting different users of said seat.
